(19) United States
(12) Patent Application Publication
(10) Pub. No.: US 2005/0277047 A1
(43) Pub. Date: Dec. 15, 2005

(54) Positively chargeable toner, positively chargeable developer and image forming method

(76) Inventor: Yasuaki Tsuji, Yokohama-shi (JP)

Correspondence Address: CANTOR COLBURN, LLP, 55 GRIFFIN ROAD SOUTH, BLOOMFIELD, CT, 06002, US

(21) Appl. No.: 11/140,852

(22) Filed: May 31, 2005

(30) Foreign Application Priority Data
Jun. 4, 2004 (JP) 2004-166923

(51) Int. Cl. G03G 9/093

(52) U.S. Cl. 430/110.2; 430/120

(57) ABSTRACT

A toner containing a copolymer containing an amine or an ammonium slat in the outer layer of the toner particle, and a positively chargeable developer containing the toner are disclosed. An image forming method to develop an electrostatic latent image employing the toner or the developer is also disclosed.

### FIELD OF THE INVENTION

The present invention is relates to a positively chargeable toner, a positively chargeable developer and an image forming method.

### TECHNICAL BACKGROUND

In an image forming method by electrophotographic system, an image is formed by developing an electrostatic latent image by a toner, and a method in which the toner is negatively charged is mainly applied for performing stable image formation for a long period. When the toner is negatively charged, complete solution of the problem of ozone generation is difficult. Recently, chances for using an apparatus such as a printer or a facsimile machine in a narrow office or a domestic room are increased accompanied with the progress of miniaturization of the apparatus. The odor of ozone gives unpleasant feeling to users even when the generation amount of which is within a low level range so as to give no bad influence to the human body. Therefore, countermeasures for ozone have been actively taken in the image forming apparatus. A typical countermeasure to ozone is an ozone filter. In this method, exhausted air from the charging device or the entire apparatus is collected at one portion and ozone is recovered by the ozone filter (or decomposed by a catalyst) for preventing the exhaustion of ozone to the atmosphere, cf. “Zoku Denshishashin Gijutsu no Kiso to Oyo (Fundamentals and Application of Electrophotographic Technology (continued edition))”, edited by the Society of Electrophotography of Japan, p.p. 238 to 241, Corona Publishing Co., Ltd., 15, Nov. 1996.

However, problems such as that the cost of the ozone filter is high and the recovery ability of the filter is lowered accompanied with the pass of the time cannot be avoided by the ozone filter. Therefore, problem of ozone is not sufficiently solved by this method.

On the other hand, an image forming method employing a positively charged toner is noted; any anxiety of the ozone generation on the occasion of the latent image formation is not caused in such the method. Among such the methods, a method is important in which a positively charged chemical toner, typically a polymerized toner prepared by forming toner particles in an aqueous medium and drying, is employed for image formation. In the chemical toner, a toner having small and uniform particle size can be obtained since the chemical toner can be prepared while controlling the particle diameter and the size distribution thereof. By such the toner, dot images in the digital system can be completely reproduced additionally to the effect for preventing the ozone generation

Moreover, a wax and a fixing aid can be added to the chemical toner in the production course thereof. Therefore, the fixing ability and the storage stability can be made compatible in the chemical toner by capsulation or surface decoration of the by the resin layer.

In the chemical toner, the shape of the toner can be, relatively easily controlled. Consequently, it is possible to produce a toner having a shape having a high transferring efficiency suitable for a cleanerless processing type image forming apparatus or a toner having a specific shape suitable for a blade cleaning process, the toner can be made applicable for a high speed apparatus for large volume of printing.

The toner can be applied for an image forming system having a high charging speed, and is suitable for image formation by a single-component developer, particularly non-magnetic single-component developer, since the shape of the toner particles easily can be made uniform and the size distribution of the toner particles can be made sharp.

However, the production of the positively chargeable toner accompanies a problem such as that acrylic acid or methacrylic acid which is a polar monomer promoting negative charging ability should be employed for stably dispersing the dispersant and the resin particles in the aqueous medium.

In known art, a compound having ammonium is internally added as a positively charging controlling agent to the toner or positively chargeable silica is externally added to the toner for giving the positively charging ability to the toner. These methods caused problems of the cost and the stability of the toner as shown, for example, in Tokkai 2003-302787.

An amorphous silicon photoreceptor excellent in the durability or an organic photoreceptor (OPC) having a stable latent image forming ability is usable for the photoreceptor for image formation by the positively chargeable toner. However, it is necessary in the image forming system by the positively charging system that the photosensitive layer provided near the surface of the photoreceptor is not severely abraded. It is difficult, therefore, to completely remove foreign substances adhering on the photoreceptor surface by a cleaning process. Consequently, a problem of image flowing caused by the foreign substances adhering on the photoreceptor surface cannot be solved. As a countermeasure for solving such the problem, polishing fine particles of from 300 to 1,000 nm is added into the toner. However, the polishing fine particles hinder the fixing ability and cause degrading in the glossiness and transparency of the color image as described, for example, in Tokkai 2001-166662.

As above-described, the image forming technology by the positively charging system is insufficient for stable image formation, and the development of the positively chargeable toner capable for reproducing a digital image with high precision is on halfway.

Non patent document 1: “Zoku Denshishashin Gijutsu no Kiso to Oyo (Fundamentals and Applications of Electrophotographic Technology (continued edition))”, edited by the Society of Electrophotography of Japan, p.p. 238 to 241, Corona Publishing Co., Ltd., 15, Nov. 1996

### SUMMARY OF THE INVENTION

The invention is attained on the above background. An object of the invention is to provide a positively chargeable toner capable of being uniformly charged on the occasion of the charging, a positively chargeable developer employing the positively chargeable toner and an image forming method by which image output can be comfortably performed without the influence of ozone on the occasion of the image formation.

Another object of the invention is to provide a positively chargeable toner, a positively chargeable developer employing the positively chargeable toner and an image forming method by which the image flowing is not caused even when no polishing particle for the photoreceptor is added to the toner.

Further object of the invention is to provide a positively chargeable toner, a positively chargeable developer employing the positively chargeable toner and an image forming method by which are excellent in the toner recycling ability and any trouble of toner scattering is not caused even when the toner is reused by returning the toner recovered from the photoreceptor cleaning device to the developing device.

The embodiments of the invention are described below.

A positively chargeable toner containing a copolymer having an amine group or an ammonium salt group in an outer layer of the particle thereof.

A positively chargeable toner containing a copolymer having a (meth)acrylamide substituted with an amine group or an ammonium salt group in an outer layer of the particle thereof.

A positively chargeable toner containing a copolymer having on of (meth)acrylamides each represented by the following formulas.

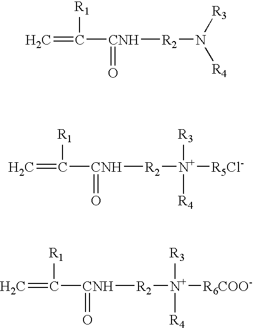

In the above, R₁, R₃, R₄ and R₅ are each an alkyl group which is preferably a saturated hydrocarbon group having 1 to 100 carbon atoms. R₂ and R₆ are each a (CH₂)ₙ group in which n is preferably 1 to 10. X is Cl, Br, I or HSO₃, and is preferably Cl.

The toner can be in a state of a double-component developer by mixing with a silicone resin covered carrier.

An image forming method in which an amorphous silicon photoreceptor exposed to digitalized light is developed by the positively chargeable toner.

An image forming method in which a positively charged photoreceptor exposed to digitalized light is developed by the positively charged toner.

According to the invention, the comfortable working condition without influence of ozone can be ensured and a printer and a copying machine for a narrow office or a domestic room can be provided.

Stable image formation can be realized for a long period of time by the positively chargeable toner which gives uniform charging ability at the time of charging and the high raising rate of charging at the time of image formation, and is capable of maintaining the charging ability for a long period.

Furthermore, according to the invention, the remaining toner and the foreign substances on the photoreceptor can be smoothly removed and suitable image formation without image flowing caused by filming can be performed even when the polishing particles are not added which hinders the fixing ability and the transparency of the image.

The positively chargeable toner, the positively chargeable developer and the image forming method can be provided, which are excellent in the toner recycling property and any trouble of toner scattering is not caused even when the toner is reused by returning the toner recovered from the photoreceptor cleaning device to the developing device.

The toner contains a resin and a colorant, and further contains a polymer having an amine or an ammonium salt in the outer layer of the particle.

By the above, the toner excellent in the positively charging ability can be obtained.

The toner is difficultly influenced by the variation in the environmental conditions because the copolymer having the amine or the ammonium salt is contained in the outer layer thereof, and is also difficultly influenced by the pressure on the occasion of printing, therefore, high durability is resulted.

In an embodiment, the toner particle has a weight average particle diameter of from 4 to 10 μm. The toner particle is constituted by a particle and a layer of the copolymer having the amine or the ammonium salt provided on the particle, which are each referred for convenience as to an inner particle and an outer layer, respectively.

The outer layer constituted by the polymer having amine or ammonium salt is provided on the surface of the inner particle in a thickness of from about 20 to about 200 nm. The diameter of the toner particle is substantially the same as that of the inner particle since the thickness of the outer layer is negligible compared with the diameter of the inner particle.

The polymer having the amine or the ammonium salt is provided on the surface of the toner particle. The inner particle preferably contains no copolymer having amine or ammonium salt, though the inner particle may contains a slight amount, for example, not more than 0.1 mole-percent, of the copolymer having amine or ammonium salt.

The outer layer occupies not less than 50%, and preferably not less than 80%, of the surface of the inner particle. The outer layer may cover the entire surface of the inner particle. The colorant necessary for the toner may be contained in the inner particle and not contained in the outer layer since the thickness of the outer layer is as thin as negligible.

The amount of the outer layer is from 1 to 50% by weight, and preferably from 5 to 50% by weight, of the entire resin particle.

The polymer constituting the outer layer is provided by polymerizing on ore more kinds of polymerizable polymer. The polymer is a homopolymer or a copolymer.

The outer layer contains the monomer having amine or ammonium salt preferably in an amount of from 0.5 to 10 mole-percent, and more preferably from 2.5 to 5.5 mole-percent, as the component constituting the resin. A copolymer containing the above amount of the monomer having ammonium or ammonium salt may be singly employed. When a homopolymer or a copolymer containing large amount of the amine or the ammonium salt is employed, the content of the amine of ammonium salt is controlled by mixing with a resin containing no amine nor ammonium salt.

### BRIEF DESCRIPTION OF THE DRAWINGS

FIG. 1 shows a schematic view of the image forming apparatus of an example of the embodiment of the invention.

FIG. 2 shows a cross sectional view of an example of developing member employed in a non-magnetic single component developer.

### DETAILED DESCRIPTION

Compound for forming a polymer containing amine or ammonium includes the following.

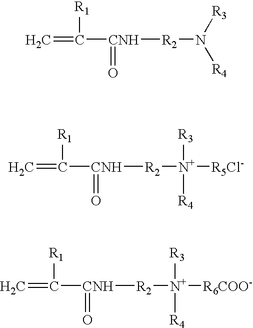

In the above, R₁, R₃, R₄ and R₅ are each an alkyl group which is preferably a saturated hydrocarbon group having 1 to 100 carbon atoms. R₂ and R₆ are each a (CH₂)ₙ group in which n is preferably 1 to 10. X is Cl, Br, I or HSO₃, and is preferably Cl.

Concrete examples of the compound having amine or ammonium salt include the followings.

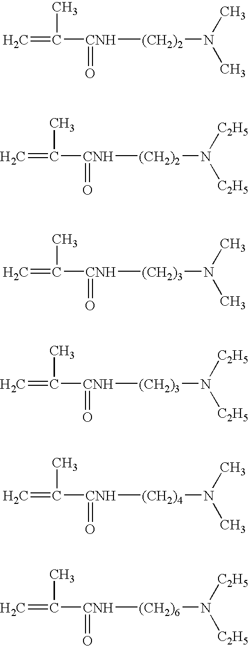

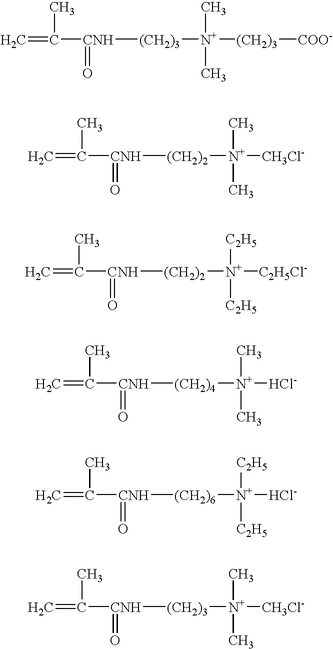

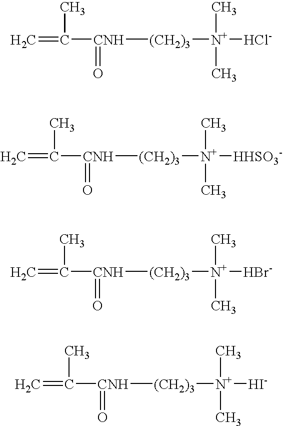

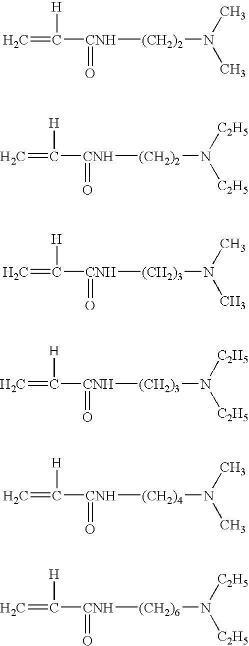

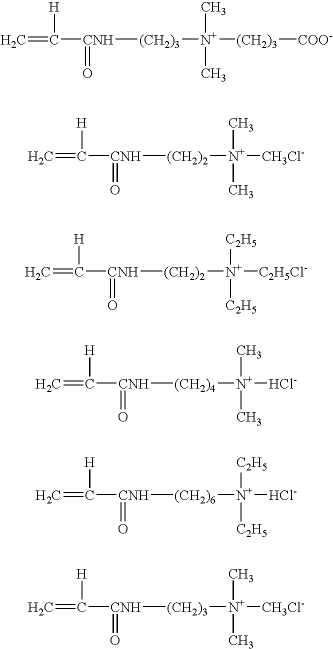

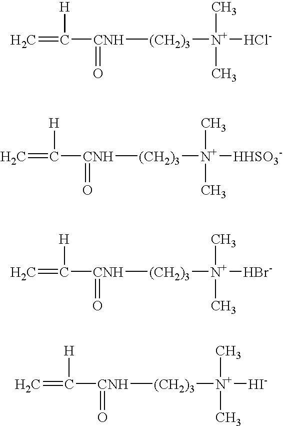

The particularly preferably compounds are:

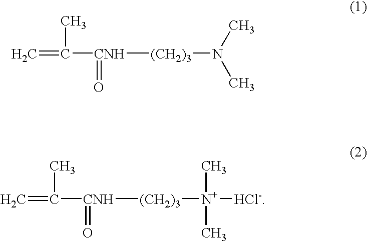

Copolymer, which composes outer layer and contains amine or ammonium salt, can be employed by polymerizing the following polymerizable monomer with amine or ammonium salt compound.

Concrete examples of the usable monomer include a mono-vinyl aromatic monomer, a (metha)acrylate monomer, a vinyl ester monomer, a vinyl ether monomer, a mono-olefin monomer, a di-olefin monomer and a halogenated olefin monomer.

Examples of the vinyl aromatic monomer include a styrene monomer and a derivative thereof such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene.

Examples of the acryl monomer include acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, and stearyl methacrylate.

Examples of the vinyl ester monomer include vinyl acetate, vinyl propionate, and vinyl benzoate. Examples of the vinyl ether monomer include vinyl methyl ether, vinyl ethyl ether, vinyl isobutyl ether and vinyl phenyl ether.

Examples of the mono-olefin monomer include ethylene, propylene, isobutylene, 1-butene, 1-pentene and 4-methyl-1-pentene. Examples of the di-olefin monomer include butadiene, isoprene and chloroprene.

Preparation of toner is described.

The toner particles are prepared by forming an outer layer of copolymer containing the amine or ammonium salt on an inner particle comprising a colorant and a binder resin. The inner layer may contain an additive such as a releasing agent.

The inner particle may be prepared by a toner particle of conventionally employed toner. The outer layer is formed by a method of polymerizing monomer containing the amine or ammonium salt, depositing or fusing polymer fine particles containing the amine or ammonium salt, or other method.

Preferable example of the preparation method is described.

Resin particles having particle size of around 200 nm by polymerization of monomer(s), and these resin particles are subjected to salting and/or fusing with a colorant to grow particle size to necessary size for a toner particle, whereby an inner particle are prepared.

To the liquid, previously prepared resin particles each containing amine or ammonium salt is added, and the outer layer is formed on the surface of the inner particle by slat out and fusion. In this occasion, it is referable that an acidic monomer is contained in the inner particle. Though the reason of this effect is not cleared yet, it is supposed that the shelling is made easy by providing anionic property to the inner portion and cationic property to the shell portion.

In other way the outer layer is formed by adding a monomer containing amine or ammonium salt and an initiator for the polymerization to the dispersion of inner particles, and causing polymerization reaction.

The other preferable example is a method in which inner particles are prepared by polymerizing a monomer(s) with a colorant and make the particle size increase to necessary size for toner particles, then, outer layer is formed on the inner particles by adding a monomer containing amine or ammonium salt and an initiator for the polymerization to the dispersion of the inner particles.

A method of preparation of inner particles with resin particles and a colorant is described. The method comprises following steps.
1: Preparation of resin particles.
2: Preparation of inner particles by salting-out/adhering the combined resin particles and colored particles.
3: Forming outer layer composed of a polymer containing amine or ammonium group on the inner particles.
4: A filtering and washing process for separating the toner particle from the dispersion system of the particle by filtration and removing the surfactant from the toner particle by washing.
5: A drying process for drying the washed toner particle.
6: A process for adding an external additive into the dried toner particle

Each step is detailed.

1: Preparation of Resin Particles.

Resin particles are prepared by preferably emulsion polymerization, and more preferably multi-step polymerization.

The multi-step polymerization process is applied for expanding the molecular weight distribution in the resin particle. Namely, the polymerization reaction is separated into plural steps for forming phases different from each other in a resin particle. The polymerization can be performed so that molecular weight distribution has an incline from the center to the surface of the resultant resin particle. For example, a method is applied in which a dispersion of high molecular weight resin is prepared firstly and then a polymerizable monomer and a chain-transfer agent are newly added to form a surface layer of low molecular weight resin. Thus formed rein particle has high strength and suitable for obtaining a toner having high anti-offset ability.

A three- or more-step polymerization is preferably applied from the viewpoint of the stability of production and the anti-crushing strength. A two-step and three-step polymerization methods are described below as typical examples of the multi-step polymerization. The toner obtained by such the multi-step polymerization preferably has the surface layer of low molecular weight resin from the viewpoint of the anti-crushing strength.

Two-Step Polymerization

The two-step polymerization is a method for producing a composite resin particle constituted by a central portion (core) of a high molecular weight resin and a surface layer of a low molecular weight resin. A crystalline substance having a parting ability may be contained in the core portion when the resin particle is employed for the inner particle of the toner.

The method is concretely described below. A monomer solution is dispersed into oil droplets in an aqueous medium, for example, an aqueous solution of a surfactant, and then the resultant system is subjected to a polymerization treatment (the first polymerization) to form a dispersion of particles of a high molecular weight resin. When the crystalline substance is added to the resin particles, a monomer solution containing the crystalline substance is employed.

After that, a monomer solution containing a polymerization initiator and a monomer is added and subjected to a polymerization treatment (the second polymerization) in the presence of the above resin particles to form a surface layer.

Three-Step Polymerization Method

The three-step polymerization method is a method for producing a resin particle having a central portion (core) constituted by a high molecular weight resin, an intermediate layer and a surface layer. The crystalline substance may be contained in the intermediate layer.

The method is concretely described below. Firstly, a dispersion of the resin particle (core) obtained by the polymerization treatment (the first step polymerization) is added to an aqueous medium (for example, an aqueous solution), and a monomer solution is dispersed into oil droplets in the aqueous medium. After that, the system is subjected to a polymerization treatment (the second polymerization) to form a covering layer (intermediate layer). Thus a dispersion of the resin particles constituted by the high molecular weight resin and the intermediate molecular weight resin is prepared. The crystalline substance can be contained in the intermediate layer by using a monomer solution in which the crystalline substance is dissolved.

A polymerization initiator and a polymerizable monomer are added to the obtained dispersion of the resin particles and the polymerizable monomer is polymerized in the presence of the resin particles (the third polymerization) to form a surface layer on the surface of the resin particles.

Resin particles each having a diameter of from 100 to 300 nm, and the inner particles are formed by slating out and fusing the dispersion.

The elements of the toner production process are described in detail below.

Polymerizable Monomer

A hydrophobic monomer is used as the essential constituent of the polymerizable monomer for forming the binder resin to be used in the invention. A monomer capable of cross-linking is used when it is necessary. It is preferable that at least one kind of monomer having an acidic polar group or a basic polar group is contained as later-mentioned.

(1) Hydrophobic Monomer

Known monomers can be used as the hydrophobic monomer constituting the monomer constituent without any limitation. One or more kinds of the monomers may be used in combination so as to satisfy the required property.

Concrete examples of the usable monomer include a mono-vinyl aromatic monomer, a (metha)acrylate monomer, a vinyl ester monomer, a vinyl ether monomer, a mono-olefin monomer, a di-olefin monomer and a halogenated olefin monomer.

Examples of the vinyl aromatic monomer include a styrene monomer and a derivative thereof such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene., p-n-decylstyrene, p-n-dodecylstyrene, 2,4-dimethylstyrene and 3,-4-dichlorostyrene.

Examples of the acryl monomer include acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate and diethylaminoethyl methacrylate.

Examples of the vinyl ester monomer include vinyl acetate, vinyl propionate and vinyl benzoate.

Examples of the vinyl ether monomer include vinyl methyl ether, vinyl ethyl ether, vinyl isobutyl ether and vinyl phenyl ether.

Examples of the mono-olefin monomer include ethylene, propylene, isobutylene, 1-butene, 1-pentene and 4-methyl-1-pentene.

Examples of the di-olefin monomer include butadiene, isoprene and chloroprene.

(2) Monomer Capable of Cross-Linking

The monomer capable of cross-linking may be added to improve the property of the resin particle. Examples of the monomer capable of cross-linking include one having two or more unsaturated bonds such as divinylbenzene, divinylnaphthalene, divinyl ether, diethylene glycol methacrylate, ethylene glycol dimethacrylate, poly(ethylene glycol) dimethacrylate and diallyl phthalate.

(3) The Monomer having an Acidic Polar Group

Examples of the monomer having an acidic polar group include (a) an α,β-ethylenic unsaturated compound having a carboxyl group —COOH and (b) an α,β-ethylenic unsaturated compound having a sulfonic acid group —SO₃H.

Examples of the α,β-ethylenic unsaturated compound having the —COOH group of (a) include acrylic acid, methacrylic acid, fumaric acid, maleic acid, itaconic acid, cinnamic acid, monobutyl maleate, monooctyl maleate and their salts of a metal such as sodium and zinc.

Examples of the α,β-ethylenic unsaturated compound having the —SO₃H group of (b) include sulfonated styrene and its sodium salt, allylsulfosuccinic acid, octyl allylsulfosuccinate and its sodium salt.

It is preferred to use the polymerizable monomer having carboxylic group (a), particularly methacrylic acid and acrylic acid.

(Surface Active Agents)

In order to perform mini-emulsion polymerization employing the aforementioned polymerizable monomers, it is required to conduct oil droplet dispersion in a water based medium employing surface active agents. Surface active agents, which are employed for said dispersion, are not particularly limited, and it is possible to cite ionic surface active agents described below as suitable ones.

Listed as ionic surface active agents are sulfonic acid salts (sodium dodecylbenzenesulfonate, sodium aryl alkyl polyethersulfonate, sodium 3,3-disulfondiphenylurea-4,4-diazo-bis-amino-8-naphthol-6-sulfonate, sodium ortho-caroxybenzene-azo-dimethylaniline-2,2,5,5-tetramethyl-triphenylmethane-4,4-diazi-bis-β-naphthol-6-sulfonate, and the like), sulfuric acid ester salts (sodium dodecylsulfonate, sodium tetradecylsulfonate, sodium pentadecylsulfonate, sodium octylsulfonate, and the like), fatty acid salts (sodium oleate, sodium laureate, sodium caprate, sodium caprylate, sodium caproate, potassium stearate, calcium oleate, and the like).

In the present invention, surface active agents represented by General Formulas (1) and (2) are most preferably employed.
R¹(OR²)ₙOSO₃M General Formula (1)
R¹(OR²)ₙSO₃M General Formula (2)

In General Formulas (1) and (2), R¹ represents an alkyl group having from 6 to 22 carbon atoms or an arylalkyl group. R¹ is preferably an alkyl group having from 8 to 20 carbon atoms or an arylalkyl group and is more preferably an alkyl group having from 9 to 16 carbon atoms or an arylalkyl group.

Listed as alkyl group having from 6 to 22 carbon atoms represented by R¹ are, for example, an n-hexyl group, an n-heptyl group, an n-octyl group, an n-decyl group, an n-undecyl group, a hexadecyl group, a cyclopropyl group, a cyclopentyl group, and a cyclohexyl group. Listed as arylalkyl groups represented by R¹ are a benzyl group, a diphenylmethyl group, a cinnamyl group, a styryl group, a trityl group, and a phenethyl group.

In General Formulas (1) and (2), R² represents an alkylene group having from 2 to 6 carbon atoms. R² is preferably an alkylene group having 2 or 3 carbon atoms. Listed as alkylene groups having from 2 to 6 carbon atoms represented R² are an ethylene group, a trimethylene group, a tetramethylene group, a propylene group, and an ethylethylene group.

In General Formulas (1) and (2), n represents an integer of 1 to 11; and n is preferably from 2 to 10, is more preferably from 2 to 5, and is most preferably 2 or 3.

In General Formulas (1) and (2), listed as univalent metal elements represented by M are sodium, potassium, and lithium. Of these, sodium is preferably employed.

Specific examples of surface active agents represented by General Formulas (1) and (2) are illustrated below:

Compound (101): C₁₀H₂₁(OCH₂CH₂)₂OSO₃Na

Compound (102): C₁₀H₂₁(OCH₂CH₂)₃OSO₃Na

Compound (103): C₁₀H₂₁(OCH₂CH₂)₂SO₃Na

Compound (104): C₁₀H₂₁(OCH₂CH₂)₃SO₃Na

Compound (105): C₈H₁₇(OCH₂CH(CH₃))₂OSO₃Na

Compound (106): C₁₈H₃₇(OCH₂CH₂)₂OSO₃Na

Releasing Agent

Known releasing agent may be employed.

The toner in which the releasing agent is finely dispersed can be produced by salting-out/fusion-adhering the resin particles including a releasing agent with the colorant particles in the aqueous medium.

Low molecular weight polypropylene having a number average molecular weight of from 1,500 to 9,000 and low molecular weight polyethylene are preferably used as the releasing agent in the toner to be used in the invention. An ester compound represented by the following formula is particularly preferred.
R¹—(OCO—R²)ₙ

In the formula, n is an integer of from 1 to 4, preferably from 2 to 4, more preferably from 3 to 4, particularly preferably 4; R¹ and R² are each a carbon hydride group which may have a substituent. R¹ is a group having from 1 to 40, preferably from 1 to 20, more preferably from 2 to 5, carbon atoms. R² is a group having from 1 to 40, preferably from 16 to 30, more preferably from 18 to 26, carbon atoms.

Typical examples of the compound are shown below.

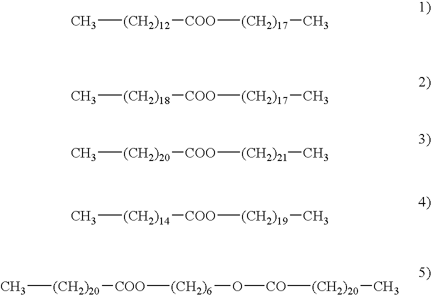

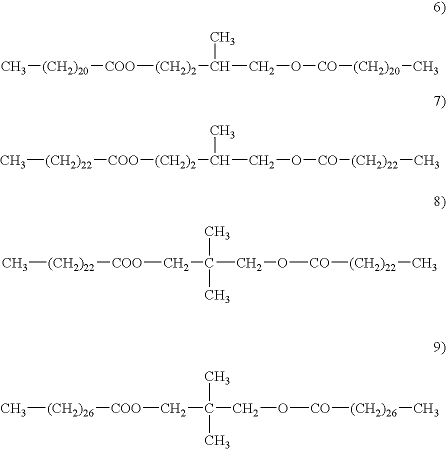

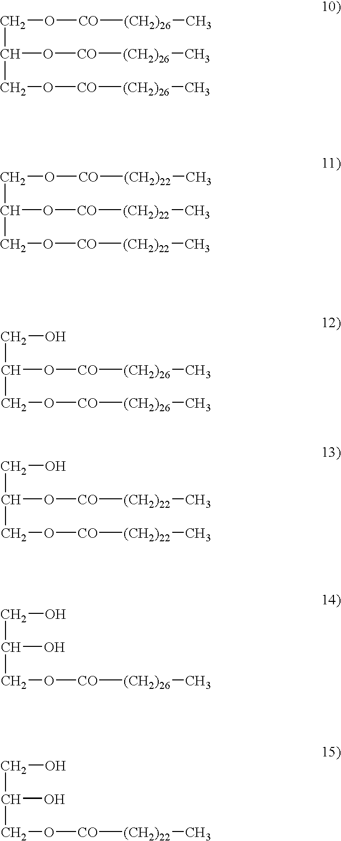

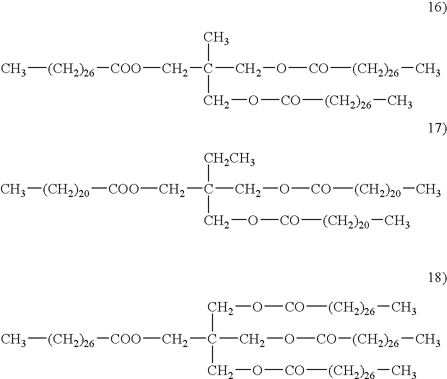

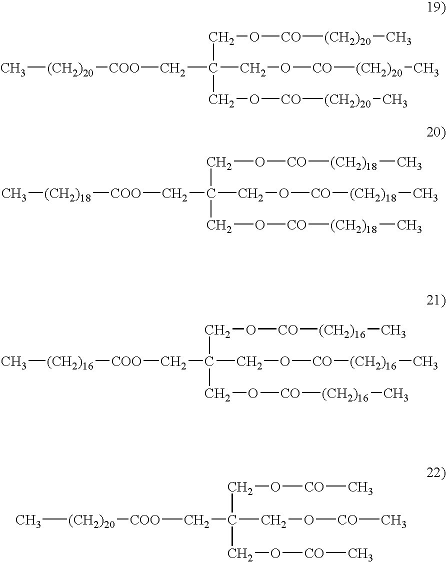

As a compound constituting crystalline polyester obtained by reaction of aliphatic diol with an aliphatic dicarboxylic acid (acid anhydride and acid chloride are included) is preferable.

As a containing ratio of the compound in the toner, it is preferable that crystalline polyester is from 1 to 30 percent by weight, and more preferably from 2 to 20 percent by weight, and in particular from 3 to 15 percent by weight of toner weight as a whole.

<Colorants>

The toner is obtained by salting out/fusing the composite resinous particles and colored particles.

Listed as colorants which constitute the toner of the present invention may be inorganic pigments, organic pigments, and dyes.

Employed as said inorganic pigments may be those conventionally known in the art. Specific inorganic pigments are listed below.

Employed as black pigments are, for example, carbon black such as furnace black, channel black, acetylene black, thermal black, lamp black, and the like, and in addition, magnetic powders such as magnetite, ferrite, and the like.

If desired, these inorganic pigments may be employed individually or in combination of a plurality of these. Further, the added amount of said pigments is commonly between 2 and 20 percent by weight with respect to the polymer, and is preferably between 3 and 15 percent by weight.

The magnetite can be added to the resinous particles when the toner is used as a magnetic toner. In this instance the magnetite is added in an amount of from 20 to 60 weight % of the toner particle in view of obtaining necessary magnetic characteristics.

The organic pigment or organic dye is also employed, examples thereof are listed.

Listed as pigments for magenta or red are C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and the like.

Listed as pigments for orange or yellow are C.I. Pigment Orange 31, C.I. Pigment Orange 43, C.I. Pigment Yellow 12, C.I. Pigment Yellow 13, C.I. Pigment Yellow 14, C.I. Pigment yellow 15, C.I. Pigment Yellow 17, C.I. Pigment Yellow 93, C.I. Pigment Yellow 94, C.I. Pigment Yellow 138, C.I. Pigment Yellow 155, C.I. Pigment Yellow 156, C.I. Pigment yellow 180, C.I. Pigment Yellow 185, Pigment Yellow 155, Pigment Yellow 186, and the like.

Listed as pigments for green or cyan are C.I. Pigment Blue 15, C.I. Pigment Blue 15:2, C.I. Pigment Blue 15:3, C.I. Pigment Blue 16, C.I. Pigment Blue 60, C.I. Pigment Green 7, and the like.

If desired, these organic pigments, as well as dyes, may be employed individually or in combination of selected ones. Further, the added amount of pigments is commonly between 2 and 20 percent by weight, and is preferably between 3 and 15 percent by weight.

The glass transition point (Tg) of the resin particle is preferably from 30 to 74° C., and more preferably from 40 to 64° C.

The softening point of the resin particle is preferably from 95 to 140° C.

The aqueous medium to be employed in the invention is a medium comprising from 50 to 100% by weight of water and from 0 to 50% by weight of a water-soluble organic solvent. The water-soluble organic solvent is preferably an alcohol type organic solvent capable of not dissolving the resin, such as methanol, ethanol, isopropanol, butanol, acetone, methyl ethyl ketone and tetrahydrofuran.

2: Process for Obtaining Inner Particle

The inner particle is obtained by salting out/fusing (the salt out and fusion are simultaneously progressed) the resin particles prepared by the foregoing multi-step polymerization and colorant particles.

The “salt out/fusion” is a phenomenon or a process in which the salt out (coagulation of the particles) and the fusion (disappearance of the interface between the particles) are simultaneously progressed. It is preferable that the resin particles and the colorant particles are coagulated at a temperature not less than the glass transition point (Tg) of the resin constituting the resin particles for simultaneously progressing the salt out and the fusion.

3: Process for Forming Outer Layer

The outer layer is formed on the inner particle in the dispersion when the diameter of the inner particle is reached necessary value.

3-A. Particles of the polymer having an amine group or an ammonium group are added to the dispersion of the inner particles and the salting out/fusion process is further continued. On this occasion a small amount of a coagulation preventing agent (coagulation inhibiting agent) is preferably added before the addition of the particles for the outer layer for preventing fusion of the inner particles with together. The coagulation preventing agent is preferably a salt capable of dissociating to a mono-valent cation.

3-B. In another method, a monomer solution containing a monomer having an amino group or an ammonium group and a material necessary for polymerization reaction such as a polymerization initiator is added to the dispersion of inner particles and the polymer having the amino group or the ammonium group is formed on the inner particles.

When the polymer particles are employed for forming the outer layer by salting out/fusing process, the diameter of the polymer particle is preferably from 100 to 500 nm, and particularly preferably from 150 to 300 nm. The outer layer preferably having a thickness of from 150 to 300 nm, and more preferably from 180 to 250 nm, can be formed by salting out/fusing the polymer particles having the above diameter.

The polymer particles having the amino group or the ammonium group can be obtained by the multi-step polymerization in a manner similar to that for forming the inner particles. The monomer having the amino group or the ammonium group is preferably employed on the last step of the multi-step polymerization (the second step of the two-step polymerization and the third step in the three-step polymerization).

The polymer particle having amino group or ammonium group may be a homopolymer particle or a copolymer particle. The homopolymer particle is employed in combination with a polymer particle having neither amino group nor ammonium group.

It is preferable that particles of the monomer having the amine or the ammonium slat are only employed as the polymer particle. The monomer constituting the resin preferably contains the amine or ammonium salt in an amount of from 0.5 to 10 mole-percent, and more preferably from 2.5 to 5.5 mole-percent.

The Tg of the resin constituting the outer layer is preferably from 40 to 80° C.

The peak molecular weight of the resin constituting the outer layer is from 1,000 to 20,000, preferably from 2,000 to 10,000, and further preferably from 3,000 to 7,000, in terms of styrene molecular weight measured by GCP, and the weight average molecular weight is preferably from 10,000 to 200,000. The adhesion ability of the outer layer with the inner particle can be increased by adjusting the peak molecular weight into the foregoing range. It is supposed that the fusion between the particles can be effectively performed by the use of the resin having the peak within the relatively low molecular weight range and the compatibility of the protective function of the surface portion and the adhesiveness between the inner particle and the outer layer can be obtained, though the reason of such the effects is not cleared yet.

The ratio A/B of the content of acidic component of A mole-percent in the inner particle to the content of amine or ammonium component of B mole-percent in the outer layer is preferably from 0.1 to 10. The surface portion can be uniformly formed by adjusting the ratio into such the range.

The toner particle dispersion is prepared by continuing stirring with a constant intensity at a temperature of neighborhood of melting point of the crystalline substance, preferably melting point ±20° after the fusion of resin particles.

4: Filtration and Washing Process

In the filtration and washing process, are applied a filtration treatment for separating toner particles by filtration from the toner particle dispersion obtained by the foregoing process, and a washing treatment for removing the substance adhered to the toner particle such as the surfactant and the salt-outing agent from the cake of the toner particles.

For the filtration treatment, a centrifuge, a vacuum filtration using a Buchner's funnel and a filtration using a filter press are applicable without any limitation.

5: Drying Process

This process is a process for drying the washed toner particles.

A spray dryer, a vacuum freezing dryer a vacuum dryer are usable in this process. A fixed rack dryer, a movable rack dryer, a fluid bed dryer, a rotary dryer and a stirring dryer are preferably usable.

The moisture content of the dried toner particles is preferably not more than 5% by weight, more preferably not more than 2%.

When the dried toner particles are coagulated by a weak attractive force between the particles, the coagulum may be subjected to a powdering treatment. For the powdering, a mechanical powdering machine such as a jet mill, a Henschel mixer, a coffee mill and a food processor is usable.

6: External Additive Adding Process

An external additive may be added to the toner according to the invention for the purpose of improving the fluidity and the cleaning ability. Various kinds of inorganic particle, organic particle and lubricant may be used without any limitation.

Inorganic particle can be used as a negative charge external additive. The negative charge silica is preferably employed because it prevents releasing from toner particles, gives charging stability, and prevents stain of a photoreceptor and a transfer member.

Fine particles of silica, titania and alumina are preferably usable. These inorganic particles are preferably hydrophilic ones.

Concrete examples of the silica fine particle include R-976, R-974, R-972, R-812 and R-809 each manufactured by Nihon Aerosil Co., Ltd., HVK-2150 and H-200, each manufactured by Hoechst Co., Ltd., and TS-720, TS-530, TS-610, H-5 and MS-5, each manufactured by Cabot Co., Ltd. They are all commercial products.

Concrete examples of the titania fine particle include MT-100S, MT-100B, MT-50OBS, MT-600, MT-600SS and JA-1, each manufactured by Teika Co,. Ltd., and TA-300SI, TA-500, TAF-130, TAF-510 and TAF-510T, each manufactured by Fuji Titan Co., Ltd., and IT-S, IT-OA, IT-OB and IT-OC, each manufactured by Idemitsu Kosan Co., Ltd. They are all commercial products.

Concrete examples of the alumina fine particle include RFY-C and C-604, manufactured by Nihon Aerosil Co., Ltd., and TTO-55, manufactured by Ishihara Sangyo Co., Ltd. They are commercial products.

An organic particle having a sphere shape and a number average primary particle diameter of approximately from 10 to 200 nm can be used as the external additive. The material of such the particle is, for example, polystyrene, poly(methyl methacrylate) or a styrene-methyl methacrylate copolymer.

A metal salt of a higher fatty acid can be used as the external additive. Concrete examples of such the metal salt of higher fatty acid include a metal stearate such as zinc stearate, aluminum stearate, cupric stearate, magnesium stearate and-calcium stearate; a metal oleate such as zinc oleate, manganese oleate, ferric oleate, cupric oleate and magnesium oleate; a palmitate such as zinc palmitate, cupric zinc palmitate, magnesium palmitate and calcium palmitate; a linolate such as zinc linolate and calcium linolate; and a ricynolate such as zinc ricynolate and calcium ricynolate.

The adding amount of the external additive is preferably from 0.1 to 5% by weight of the toner.

Various know mixing apparatus such as a tabular mixer, a Henschel mixer, a Nauter mixer and a V-type mixer are usable for adding the external additive to the toner.

It is not necessary to add abrasive particles as the external additive.

Positive charge developer is detailed.

The toner according to the invention may be used either for a one-component developer or a two-component developer.

A positive charge two-component developer is described, in which a positive charge toner and a carrier are mixed to used.

A carrier composed of the magnetic particle coated with resin or a resin disperse type carrier in which the magnetic particles are dispersed in resin is preferably used. An olefin resin, a styrene resin, a styrene-acryl resin, a silicone resin, an ester resin or a fluorine-containing polymer resin is usable. A fluorine-containing resin is preferable.

A metal, for example, iron, ferrite and magnetite, and an alloy of the metal with aluminum may be used for the magnetic particle. Ferrite is particularly preferred.

The volume average particle diameter of the carrier is preferably from 15 μm to 100 μm, more preferably from 25 μm to 80 μm. The volume average particle diameter of the carrier can be measured by a laser diffraction particle size distribution measuring apparatus “HELOS” having a wet dispersing device, manufactured by Sympatec Co., Ltd.

For the photoreceptor relating to the invention, a positively chargeable organic photoreceptor (OPC) or amorphous silicone photoreceptor are preferably employed. Images can be obtained stably for a prolonged period by using a combination of a positively chargeable toner and the positively chargeable developer relating to the invention.

The positively chargeable organic photoreceptor preferably has a multi-layered structure in which an under coating layer (UCL) is provided on an electroconductive substrate and a charge transfer layer (TCL) and a charge generation layer (CGL), functionally separated from each other, are successively provided on the under coating layer. However, a structure in which a photoreceptor having both of a charge generation function and a charge transfer function is provided on the under coating layer coated on the electroconductive substrate may be applied for a positively chargeable photoreceptor having a single layer structure.

The amorphous silicon photoreceptor is a photoreceptor having an amorphous silicon layer (sometimes referred to as a-Si) or a non-crystalline silicon layer, and known amorphous silicone type photoreceptors are usable, which are described in Tokkai Sho 54-83746, 57-11556, 60-67951, 62-168161 and 57-168650.

The image forming method relating to the invention is preferably a method in which an image is formed by a positively charging system using the positively charged toner of the invention by means of an image forming apparatus having the amorphous silicon photoreceptor or the positively chargeable organic photoreceptor.

An intermediate transfer belt tandem type color image forming apparatus is described below as an example of the image forming apparatus relating to the invention.

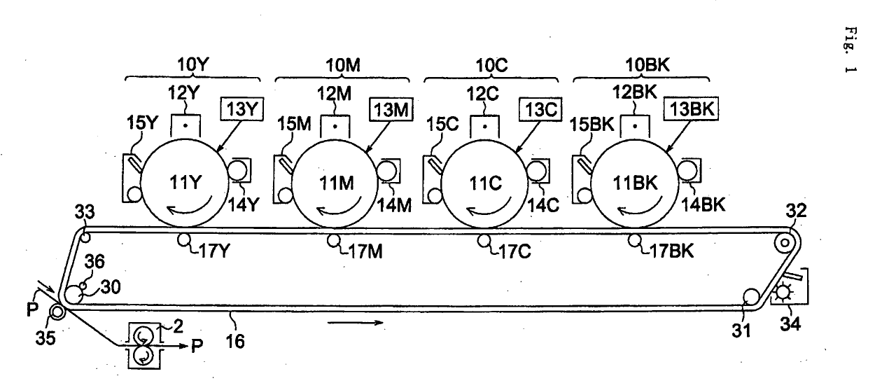

FIG. 1 shows a schematic drawing of an example of the image forming apparatus relating to the invention.

The image forming apparatus shown in FIG. 1 can be applied as a copy machine and a laser printer. The image forming apparatus shown in FIG. 1 has units 10Y, 10M, 10C and 10Bk, a belt shaped intermediate transfer member 16, transfer rollers 17Y, 17M, 17C and 17Bk, a recording paper conveying roller 18 and a fixing device 2. In the invention, the foregoing belt shaped intermediate transfer member relating to the invention is employed as the intermediate transfer belt 16. In the invention, polyimide resin is employed for the material of the belt of the intermediate transfer member 16 and that of the endless belt of the later-mentioned fixing device 2. The polyimide resin to be employed for the material of the belt used in the image forming apparatus relating to the invention is described later.

In each of the units 10Y, 10M, 10C and 10Bk, photoreceptor drums 11Y, 11M, 11C and 11Bk are installed rotatably in a designated circumference speed or processing speed, respectively. A flange is fixed to each of the photoreceptor even though which is not shown in the drawing. Around each of the photoreceptor drums, the followings are arranged; scorotron charging devices 12Y, 12M, 12C and 12Bk, exposing devices 13Y, 13M, 13C and 13Bk, developing devices for each color (a yellow developing device 14Y, a magenta developing device 14M, a cyan developing device 14C and a black developing device 14Bk) and photoreceptor cleaners 15Y, 15M, 15C and 15Bk.

Though the units 10Y, 10M, 10C and 10Bk are arranged in parallel to the intermediate transfer belt 16, the order of the unit may be optionally decided corresponding to the image forming method.

The intermediate transfer belt 16 can be circulated anti-clockwise in the same circumference speed as that of the photoreceptor drums 11Y, 11M, 11C and 11Bk by a backup roller 30 and support rollers 31, 32 and 33 so that parts of the belt between the support rollers 32 and 33 are contacted with the photoreceptor drums 11Y, 11M, 11C and 11Bk. A cleaning device 34 is provided to the transfer belt 16. The support roller 31 functioning as a tension roller is arranged so as to be movable in the direction to the intermediate transfer belt 16 and is capable of controlling the tension of the intermediate transfer belt 16.

Transfer rollers 17Y, 17M, 17C and 17Bk are arranged at inside of the intermediate transfer belt 16 each so as to face to the positions where the photoreceptor drums 11Y, 11M, 11C and 11Bk are each contacted with the intermediate transfer belt 16, and primary transfer portions or nip portions are formed where the toner images on the photoreceptor drums 11Y, 11M, 11C and 11Bk are each transferred to the intermediate transfer belt 16.

A bias roller 35 is arranged on the surface side of the transfer belt 16 on which the toner image is carried so as to face to a backup roller 30 through the intermediate transfer belt 16. The secondary transfer portion or nip portion is formed between the bias roller 35 through the intermediate transfer belt and the backup roller. An electrode roller 26 is provided to the backup roller 30, which is contacted with pressure to the backup roller and rotated according to the backup roller 30.

The fixing device 26 is arranged so that a recording sheet P can be conveyed by it after passing through the secondary transfer portion.

In the image forming apparatus-shown in FIG. 1, the photoreceptor drum 11Y of the unit 11 is rotated by diving and the scorotron charging device 12 is driven synchronously with the photoreceptor drum for uniformly charging the photoreceptor drum 11Y at a designated polarity and potential. The photoreceptor drum 11Y uniformly charged on the surface is imagewise exposed by the exposing device 13Y so as to form a static latent image on the surface thereof.

The static latent image is developed by the yellow developing device 14Y. Thus a toner image is formed on the surface of the photoreceptor drum 11Y.

The toner image is primarily transferred onto the intermediate transfer belt 16 at the time of passing the primary transfer portion between the photoreceptor drum 11Y and the intermediate transfer belt 16 by means of a bias potential for transferring applied at this time.

After that, the toner remaining on the photoreceptor drum 11Y is removed by the photoreceptor cleaner 15Y. And then the photoreceptor is prepared to the next transferring cycle.

The above transfer cycle is similarly repeated in the units 10M, 10C and 10Bk and the second, third and fourth color images are successively formed and piled on the transfer belt 16 so as to form a full color toner image.

The full color toner image transferred on the transfer belt 16 is arrived at the secondary transfer portion (nip portion) having the bias roller 35 by the rotation of the transfer belt 16.

The recording sheet P is conveyed between the intermediate transfer belt 16 and the bias roller 35 at the secondary transfer portion with a designated timing. The toner image carried on the intermediate transfer belt 16 is transferred onto the recording sheet P by the pressing and conveying by the bias roller 35 and the backup roller 30 and the circulation of the intermediate transfer belt 16.

The recording sheet P on which the toner image is transferred is conveyed to the fixing device 2 and the toner image is fixed by pressing/heating treatment. Thereafter, intermediate transfer belt 16 is prepared for next transferring after removing of the remaining toner by the belt cleaning device 34 provided at the lower course of the secondary transfer portion.

Polyimide resin is preferably employed for the material of intermediate transfer belt and the endless belt of the fixing device relating to the invention.

In the image forming apparatus shown in FIG. 1, the positively chargeable organic photoreceptor or amorphous silicon photoreceptor can be employed, and a developing device for a magnetic double-component developer or a non-magnetic single component developer can be employed.

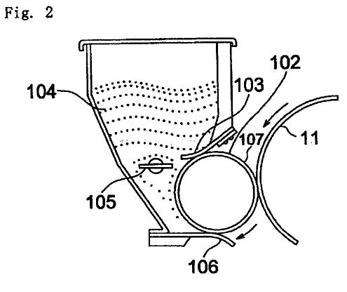

FIG. 2 shows a cross section of an example of the developing device for the non-magnetic single-component developer.

In FIG. 2, 11 is the photoreceptor drum, 102 is a developing roller, 103 is a metal elastic blade, 104 is the single-component developer, 105 is a stirring wing, 106 is a recovery plate and 17 is silicone resin. The developing roller 102 is covered with silicone resin 107.

### EXAMPLES

The invention is described referring examples below. However, the invention is not limited to the examples.

### Example 1

<Preparation of Toner 1-C>

Colored particle dispersion M1 to be formed an inner layer and resin particle dispersion for outer layer S1 were each prepared. And then Toner C-1 was prepared by mixing the dispersions M1 and S1 so that the resin particles for outer layer were fixed on the surface of the colored particles.

1. Process for Preparing the Resin Particle Dispersion for Outer Layer

The resin particle dispersion for outer layer S1 containing resin particles for outer layer s1 to be fixed onto the colored particle surface for forming the inner layer was prepared.

Polymerizable monomer solution 1-1-1

The following composition was referred to as polymerizable monomer solution 1-1-1.

| | | |
|---|---|---|
| Styrene | 70.1 | g |
| n-Butyl acrylate | 19.9 | g |
| Methacrylic acid | 10.9 | g |
| Compound 1 | 4.5 | g |

In a 5,000 ml separable flask to which a stirring device, a thermal sensor, a cooler and a nitrogen introducing device, 7.08 g of anionic surfactant 102 C₁₀H₂₁(CH₂CH₂)₃OSO₃Na was dissolved in 3,010 g of deionized water and the temperature of the solution was raised by 80° C. while stirring in a nitrogen atmosphere to prepare a surfactant solution. To the surfactant solution, an initiator solution prepared by dissolving 9.2 g of an initiator (potassium persulfate KPS) in 200 g of deionized water was added and the temperature was adjusted at 75° C., and then the polymerizable monomer solution 1-1-1 was dropped spending for 1 hour. After completion of the dropping, the system was heated and stirred for 2 hours at 75° C. for performing polymerization (the first step polymerization) to form the resin particles. The resin particle was referred to as the resin particle for outer layer 1-1-1.

Polymerizable Monomer Solution 1-1-2

In a flask having a stirring device, 96.0 g of a parting. agent, Exemplified Compound 19, was dissolved in the following polymerizable monomer mixture and dissolved at 80° C. The solution was referred to as polymerizable monomer solution 1-1-2.

| | | |
|---|---|---|
| Styrene | 122.9 | g |
| n-Butyl acrylate | 49.7 | g |
| Methacrylic acid | 16.3 | g |

In a 5,000 ml separable flask to which a stirring device, a thermal sensor, a cooler and a-nitrogen introducing device, 5.7 g of anionic surfactant 102 C₁₀H₂₁(CH₂CH₂)₃OSO₃Na was dissolved in 1,340 g of deionized water to prepare a surfactant solution. The surfactant solution was heated by 80° C. and the polymerizable monomer solution 1-1-2 was mixed and dispersed in the surfactant solution for 2 hours by a mechanical disperser having a circulation pass CLEARMIX, manufactured by M-Technique Co., Ltd., to prepare a dispersion (emulsion) containing emulsified particles (oil droplets) having a dispersed particle diameter of 646 nm. After that, 1,640 ml of deionized water, an initiator solution prepared by dissolving 6.51 g of the initiator (potassium persulfate, KPS) in 245 ml of deionized water, and 0.7 5 g of n-octyl-3-mercaptopropionate were added to the above-obtained resin particles for outer layer 1-1-1. This system was heated and stirred for 3 hours at 80° C. for performing the polymerization (the second step polymerization) to obtain resin particles including the resin particles for outer layer 1-1-1 as the raw material. Thus obtained resin particle was referred to as resin particle for outer layer 1-1-2.

To thus obtained resin particle for outer layer 1-1-2, an initiator solution prepared by dissolving 8.87 g of the initiator (potassium persulfate, KPS) in 346 ml of deionized water, and the following polymerizable monomer solution 1-1-3 was dropped spending for 1 hour at a temperature of 80° C.

Polymerizable monomer solution 1-1-3

| | |
|---|---|
| Styrene | 322.3 g |
| n-Butyl acrylate | 121.9 g |
| Methacrylic acid | 35.5 g |
| Compound below | 4.5 g |
| 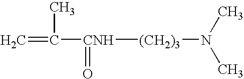 | |
| n-Octylmercaptan | 6.4 g |

After completion of the dropping, polymerization (the third step of polymerization) was carried out by heating and stirring for 2 hours and then cooled by 28° C. to obtain a dispersion of silicone resin particles for outer layer s1 including the silicone resin particle for outer layer 1-1-2 as the raw material. This resin particle dispersion was referred to as Silicone resin particle dispersion for outer layer S1.

2. Process for Preparing Resin Particle Dispersion for Inner Layer

2-1. Preparation of Resin Particle for Forming the Inner Layer of Toner Particle

Polymerizable Monomer Solution 2-1-1

In a flask having a stirring device, 96.0 g of the parting agent, Exemplified Compound 19, was added to the following mixture of polymerizable monomers and dissolved by heating by 80° C. This solution was referred to as polymerizable monomer solution 2-1-1.

| | | |
|---|---|---|
| Styrene | 172.9 | g |
| n-Butyl acrylate | 55.0 | g |
| Methacrylic acid | 23.1 | g |

In a 5,000 ml separable flask, on which a stirrer, thermal sensor and cooler are attached, 2.1 g of anionic surfactant (exemplified compound 101) as dissolved in 1,240 ml of deionized water to prepare a surfactant solution. The surfactant solution was heated by 80° C. and the above polymerizable monomer solution 2-1-1 was mixed and dispersed in the surfactant solution spending for 2 hours by the mechanical disperser having a circulation pass CLEARMIX, manufactured by M-Technique Co., Ltd. Thus an emulsion (dispersion) containing emulsion particles (oil droplets) having a dispersed particle diameter of 482 nm was obtained.

After that 1,460 ml of deionized water was added and then an initiator solution prepared by dissolving 7.5 g of the initiator (potassium persulfate, KPS) in 124 ml of deionized water and 6.74 g of n-octanethiol were added and heated and stirred for 3 hours at 80° C. for performing polymerization (the first polymerization step) to obtain resin particles for inner layer which was referred to as resin particle for inner layer 2-1-2.

To the above obtained dispersion, an initiator solution prepared by dissolving 11.6 g of the initiator (KPS) in 142 ml of deionized water, and the following polymerizable monomer solution 2-1-2 was dropped spending for 1 hour at a temperature of 80° C.

Polymerizable monomer solution 2-1-2

| | | |
|---|---|---|
| Styrene | 291.2 | g |
| n-Butyl acrylate | 132.2 | g |
| Methacrylic acid | 42.9 | g |
| n-Octanethiol | 7.51 | |

After completion of the dropping, polymerization (the second step of polymerization) was carried out by heating and stirring for 2 hours and then cooled by 28° C. to obtain a dispersion of resin particles for inner layer 2-1-2 including the resin particle for inner layer 2-1-1 as the raw material.

2-2. Process for Coagulation of the Inner Layer of Toner Particle

A salt out/fusion process was performed by using the following colorant dispersion and the above resin particle dispersion of inner layer 2-1-2.

Preparation of Colorant Dispersion C

A surfactant solution was prepared by dissolving.59.0 g of the anionic surfactant 101 in 1,600 ml of deionized water, and 280.0 g of a cyan pigment C. I. Pigment Blue 15:1 was gradually added to the surfactant solution while stirring and dispersed by CLEARMIX, manufactured by M-Technique Co., Ltd., to prepare colorant dispersion C.

Into a four-mouth flask, on which a thermal sensor, cooler, nitrogen introducing device and stirrer were attached, 259.3 g of the resin particles-2-1-2 in terms of solid ingredient, 1,120 g of deionized water and 237 g of the above colorant dispersion C were charged and stirred. The temperature of the contents of the flask was adjusted at 30° C. and then pH was adjusted at 10 by addition of a 5 moles/liter solution of sodium hydroxide.

After that, a solution prepared by dissolving 55.3 g of magnesium chloride hexahydrate in 55.3 ml of deionized water was added spending for 10 minutes at 30° C. After standing for 3 minutes, this system was heated by 90° C. spending for 60 minutes for performing the salt out/fusion of the resin particles for inner layer and the colorant particles.

The diameter of the particle to be the inner layer was measured by Coulter Counter TA-II, manufactured by Beckman Coulter Co., Ltd., while continuing the stirring and heating, and a solution prepared by dissolving 15.3 g of sodium chloride in 100 ml of deionized water was added for inhibiting the growth of the particles at the time when the volume average particle diameter become to 5.5 μm.

3. Process for Forming the Outer Layer of Toner

The pH of the resin particle dispersion for outer layer Si containing 87.5 g of solid ingredient was adjusted to 8 by addition of a 5 moles/liter solution of sodium hydroxide.

A resin particle dispersion for inner layer Ml was heated and stirred for 1 hour or more and the above resin particle dispersion for outer layer S1 was added at the time when the circular degree of the particle was arrived at 0.944 for forming the outer layer by fusing the resin particle for outer layer s1 onto the surface of the inner layer.

After that, a solution prepared by dissolving 123.9 g of sodium chloride in 500 g of deionized water was added for lowering the coagulation force of the particles and then the heating and stirring was further continued for 2 hours at 95° C. Thereafter, the dispersion was cooled by 30° C. in a rate of 8° C./minute, and the pH was adjusted to 2 by addition of hydrochloric acid and then the stirring was stopped. Thus obtained dispersion was referred to as dispersion of Toner Particle 1-C. The circular degree of Toner Particle 1-C was 0.964.

4. Separation and Washing of Solid Ingredient

The dispersion of Toner Particle 1-C was separated by centrifugation and washed by sprinkling deionized water in an amount of 20 times of the solid ingredient. Thus Toner Cake 1-C was obtained.

5. Drying Process

Thus obtained washed Toner Cake 1-C was dried by a vacuum dryer until the moisture content become 4% by weight to obtain Toner Particle 1-C.

External Additive Mixing Process

To the above obtained Toner Particle, 0.8 parts by weight of hydrophilic silica R805, manufactured by Nihon Aerosil Co., Ltd., was added and mixed for 25 minutes by a Henschel mixer, manufactured by Mitsui Miike Kako CO., Ltd., at a circumference speed of the rotating wing of 30 m/second. After that, the particles were sieved by a sieve having an opening size of 45 μm for removing coarse particles. Thus Toner 1-C composed of Toner Particle 1-C was prepared.

Preparation of Toner 1-M

Toner 1-M was prepared in the same manner as in Toner 1-C except that 420 g of magenta pigment C. I. Pigment Red 184 was employed in place of 280.0 g of cyan pigment C. I. Pigment Blue 5:1.

Preparation of Toner 1-Y

Toner 1-Y was prepared in the same manner as in Toner 1-C except that 420 g of yellow pigment C. I. Pigment Yellow 74 was employed in place of 280.0 g of cyan pigment C. I. Pigment Blue 5:1.

Preparation of Toner 1-Bk

Toner 1-Bk was prepared in the same manner as in Toner 1-C except that 420 g of neutral carbon black Regal 660, manufactured by Cabot Co., Ltd., was employed in place of 280.0 g of cyan pigment C. I. Pigment Blue 5:1.

### Example 2

Preparation of Toner 2-C

Toner 2-C was prepared in the same manner as in Toner 1-C except that Compound 1 employed for preparation of resin particle s1 for outer layer of Toner 1-C was replaced by Compound 2.

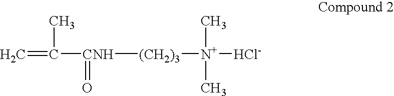

Preparation of Toner 2-M

Toner 2-M was prepared in the same manner as in Toner 2-C except that 420 g of magenta pigment C. I. Pigment Red 184 was employed in place of 280.0 g of cyan pigment C. I. Pigment Blue 5:1.

Preparation of Toner 2-Y

Toner 2-Y was prepared in the same manner as in Toner 2-C except that 420 g of yellow pigment C. I. Pigment Yellow 74 was employed in place of 280.0 g of cyan pigment C. I. Pigment Blue 5:1.

Preparation of Toner 2-Bk

Toner 2-Bk was prepared in the same manner as in Toner 2-C except that 420 g of neutral carbon black Regal 660, manufactured by Cabot Co., Ltd., was employed in place of 280.0 g of cyan pigment C. I. Pigment Blue 5:1.

### Comparative Example 1

Preparation of Toner 3-C

Toner 3-C was prepared in the same manner as in Toner 1-C except that Compound 1 was omitted.

Preparation of Toner 3-M

Toner 3-M was prepared in the same manner as in Toner 3-C except that 420 g of magenta pigment C. I. Pigment Red 184 was employed in place of 280.0 g of cyan pigment C. I. Pigment Blue 5:1.

Preparation of Toner 3-Y

Toner 3-Y was prepared in the same manner as in Toner 3-C except that 420 g of yellow pigment C. I. Pigment Yellow 74 was employed in place of 280.0 g of cyan pigment C. I. Pigment Blue 5:1.

Preparation of Toner 3-Bk

Toner 3-Bk was prepared in the same manner as in Toner 3-C except that 420 g of neutral carbon black Regal 660, manufactured by Cabot Co., Ltd., was employed in place of 280.0 g of cyan pigment C. I. Pigment Blue 5:1.

### Comparative Example 2

Preparation of Toner 4-C

Toner 4-C was prepared in the same manner as in Toner 1-C except that 259.3 g of resin particle for inner layer 2-1-2 in terms of solid ingredient, 1,120 g of deionized water and 23.7 g of colorant dispersion C were coagulated and the formation of the outer layer was omitted.

Preparation of Toner 4-M

Toner 4-M was prepared in the same manner as in Toner 4-C except that 420 g of magenta pigment C. I. Pigment Red 184 was employed in place of 280.0 g of cyan pigment C. I. Pigment Blue 5:1.

Preparation of Toner 4-Y

Toner 4-Y was prepared in the same manner as in Toner 4-C except that 420 g of yellow pigment C. I. Pigment Yellow 74 was employed in place of 280.0 g of cyan pigment C. I. Pigment Blue 5:1.

Preparation of Toner 4-Bk

Toner 4-Bk was prepared in the same manner as in Toner 4-C except that 420 g of neutral carbon black Regal 660, manufactured by Cabot Co., Ltd., was employed in place of 280.0 g of cyan pigment C. I. Pigment Blue 5:1.

The employed copolymer and the circular degree of the toner particle are shown in Table 1.

TABLE 1

| | Compound having | Average circular | |
|---|---|---|---|
| Toner | amine or ammonium | degree of toner | |
| No. | salt | particles | Remarks |
| 1-C | Compound (1) | 0.964 | |
| 1-M | Compound (1) | 0.961 | |
| 1-Y | Compound (1) | 0.963 | |
| 1-Bk | Compound (1) | 0.962 | |
| 2-C | Compound (2) | 0.961 | |
| 2-M | Compound (2) | 0.962 | |
| 2-Y | Compound (2) | 0.965 | |
| 2-Bk | Compound (2) | 0.964 | |
| 3-C | | 0.961 | No Compound (*) |
| 3-M | | 0.965 | No Compound (*) |
| 3-Y | | 0.962 | No Compound (*) |
| 3-Bk | | 0.963 | No Compound (*) |
| 4-C | | 0.991 | No outer layer |
| 4-M | | 0.963 | No outer layer |
| 4-Y | | 0.964 | No outer layer |
| 4-Bk | | 0.961 | No outer layer |

(*) No compound having amine or ammonium salt is contained.

<<Preparation of Double-Component Developer>>

In a covering resin solution prepared by dissolving 1 part by weight of a condensation reaction type silicone resin in 50 parts by weight of xylene, 100 parts by weight of ferrite particles having a volume average particle diameter of 40 μm were immersed. After that, xylene was removed by heating and the ferrite particles were sintered at 200° C. for 3 hours. The coagulated particles were removed by sieving to prepare a carrier having a coated layer of the silicone resin.

Double-component developer was prepared by mixing each of the above prepared toners and the carrier by a V-type mixer so that the toner concentration was 6% by weight.

<<Evaluation>>

The valuation was performed by the use of the following 2 kinds of evaluation machine.

Evaluating Machine 1

An electrophotographic printer available on the market EPSON 9500, manufactured by Epson Co., Ltd., was employed, in which the photoreceptor was exchanged by the positively chargeable photoreceptor and the developing device was changed to a developing-device for non-magnetic one-component developer employing a developing roller covered with silicone resin so that the image forming process can be performed by positively charging.

Evaluating Machine 2

An electrophotographic printer available on the market STIOS 9331, manufactured by Konica Minolta Corp., was employed, in which the photoreceptor was exchanged by an amorphous silicon photoreceptor so that the image forming process can be performed by positively charging.

The evaluation was performed about the following items by charging each of the above prepared toners or the double-component component developer in the evaluation machine and printing an image.

Evaluation Using the Evaluation Machine 1

Stability of Image—Line Width

A line chart having a line width of 100 μm was continuously printed for 100,000 sheets through one day and night by each of the colors of C, M, Y and Bk, and the width of the printed line was measured on every 10,000^{th} prints.

Evaluating Norms

A: The line width of each of the colors was within the range of 100±5 μm.

B: The line width of each of the colors was within the range of 100±10 μm.

C: The line width of any one of the colors was without the range of 100±10 μm in some samples.

Stability of Image—Difference of the Mode

A full color image including a character and a photograph was printed for 5,000 sheets and then a black character image was printed for 5,000 sheets, and such the cycle was repeated for 5 times. Solid images were printed by each color at the changing of the above images and the uniformity of the printed image was visually evaluated.

Evaluation Norms

A: Unevenness in the image density,was not observed at all and uniform image was only obtained; excellent.

B: Though unevenness in the image density was observed at a little parts of the image, no problem was caused in practical use; good.

C: White portion such as lacking of transfer was partially observed or roughness was felt in the image quality; poor.

Image Flowing caused by Filming on Photoreceptor

The surface of photoreceptor was visually observed after printing of 300,000 sheets and the image flowing caused by filming (adhesion of contaminator on the photoreceptor) was visually evaluated.

The image flowing was an image defect such as blur of outline of character or scatter of toner around the character when image of 8-point characters was fully printed on a sheets on the next morning the day on which printing was continuous performed through one day.

A: No filming and no image flowing were observed at the time of printing of 300,000^{th} sheets.

B: The filming was slightly observed at the time of printing of 300,000^{th} sheets but the image flowing was not caused.

C: The filming was caused on the photoreceptor surface and the image flowing was frequently also caused before 300,000^{th} sheets of printing.

Suitability for Toner Recycling

The testing machine was modified so that the toner recovered by the photoreceptor cleaning device was recycles to the developing device, and an image having a ratio of black image of 6%, that of red image of 0.6% and that of green of 0.6% was printed for 100,000 sheets.

Evaluation Norms

A: Color mixing and toner scattering in the interior of the machine were not causes.

B: Though toner scattering was slightly observed, cleaning in the machine was not necessary.

C: Image contamination caused by color mixing and toner scattering were observed on the image.

Evaluation results by Evaluation Machine 1 are listed in Table 2.

TABLE 2

| | | | | Image flowing | |
|---|---|---|---|---|---|
| | | Stability | Stability | caused by | Suitability |
| | | of image | of image | filming on | for toner |
| | Toner | (*) | (**) | photoreceptor | recycling |
| Example 1 | 1-C, | A | A | A | A |
| | 1-M, | | | | |
| | 1-Y, | | | | |
| | 1-Bk | | | | |
| Example 2 | 2-C, | A | A | B | A |
| | 2-M, | | | | |
| | 2-Y, | | | | |
| | 2-Bk | | | | |
| Comp. | 3-C, | C | C | C | C |
| Example 1 | 3-M, | | | | |
| | 3-Y, | | | | |
| | 3-Bk | | | | |
| Comp. | 4-C, | C | C | C | C |
| Example 2 | 4-M, | | | | |
| | 4-Y, | | | | |
| | 4-Bk | | | | |

(*) Line width
(**) Difference of the mode

Evaluation using Evaluating Machine 2
Stability of Image—Line Width

A line chart having a line width of 100 μm was continuously printed for 100,000 sheets through one day and night by each of the colors of C, M, Y and Bk, and the width of the printed line was measured on every 10,000 prints.

Evaluating Norms

A: The line width of each of the colors was within the range of 100±5 μm.

B: The line width of each of the colors was within the range of 100±10 μm.

C: The line width of any one of the colors was without the range of 100±10 μm in some samples.

Stability of Image—Difference of the Mode

A full dolor image including a character and a photograph was printed for 5,000 sheets and then a black character image was printed for 5,000 sheets, and such the cycle was repeated for 5 times. Solid images were printed by each color at the changing of the above images and the uniformity of the printed image was visually evaluated.

Evaluation Norms

A: Unevenness in the image density was not observed at all and uniform image was only obtained; excellent.

B: Though unevenness in the image density was observed at a little parts of the image, no problem was caused in practical use; good.

C: White portion such as lacking of transfer was partially observed or roughness was felt in the image quality; poor.

Image Flowing

The surface of photoreceptor was visually observed after 1,000,000 sheets of printing and the image flowing caused by filming (adhesion of contaminator on the photoreceptor) was visually evaluated.

The image flowing was image defects such as blur of outline of character or scatter of toner around the character when image of 8-point characters was fully printed on a sheet on the next morning the day on which printing was continuous performed through one day.

A: No filming and no image flowing were observed at the time of printing of 1,000,000^{th} sheet.

B: The filming was slightly observed at the time of printing of 1,000,000^{th} sheet but the image flowing was not caused.

C: The filming was caused on the photoreceptor surface and the image flowing was frequently also caused before 1,000,000 sheets of printing.

Suitability for Toner Recycling

The testing machine was modified so that the toner recovered by the photoreceptor cleaning device was recycles to the developing device, and an image having a ratio of black image of 6%, that of red image of 0.6% and that of green of 0.6% was printed for 100,000 sheets.

Evaluation Norms

A: Color mixing and toner scattering in the interior of the machine were not causes.

B: Though toner scattering was slightly observed, cleaning in the machine was not necessary.

C: Image contamination caused by color mixing and toner scattering were observed on the image.

Evaluation results by Evaluation Machine 1 are listed in Table 3.

TABLE 3

| | | | | Image flowing | |
|---|---|---|---|---|---|
| | | Stability | Stability | caused by | Suitability |
| | | of image | of image | filming on | for toner |
| | Toner | (*) | (**) | photoreceptor | recycling |
| Example 1 | 1-C, | A | A | A | A |
| | 1-M, | | | | |
| | 1-Y, | | | | |
| | 1-Bk | | | | |
| Example 2 | 2-C, | A | A | B | A |
| | 2-M, | | | | |
| | 2-Y, | | | | |
| | 2-Bk | | | | |
| Comp. | 3-C, | C | C | C | C |
| Example 1 | 3-M, | | | | |
| | 3-Y, | | | | |
| | 3-Bk | | | | |
| Comp. | 4-C, | C | C | C | C |
| Example 2 | 4-M, | | | | |
| | 4-Y, | | | | |
| | 4-Bk | | | | |

(*) Line width
(**) Difference of the mode

It is understood form Tables 2 and 3 that Toners 1-C through 2-Bk of the examples of the invention are superior to Toners 3-C through 4-Bk of the comparative examples in the entire evaluation items.

1. A toner for forming an electrostatic image comprising a particle containing a colorant and a binder and an outer layer provided on the surface of the particle, wherein the outer layer comprises a polymer containing a amine or ammonium salt.

2. The toner of claim 1, wherein the polymer comprises acrylamide or methacrylamide substituted by amine or ammonium salt as a recurring unit of the polymer.

3. The toner of claim 2, wherein the acrylamide or methacrylamide substituted by amine or ammonium salt is a compound represented by each of following formulas. 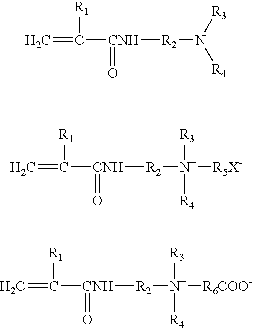
wherein R₁, R₃, R₄ and R₅ are a hydrogen atom or an alkyl group, and R₂ and R₆ are (CH₂)ₙ, n being 1-10, and X is Cl, Br, I or HSO₃.

4. The toner of claim 3, wherein the acrylamide or methacrylamide substituted by amine or ammonium salt is a compound represented by each of following formulas.

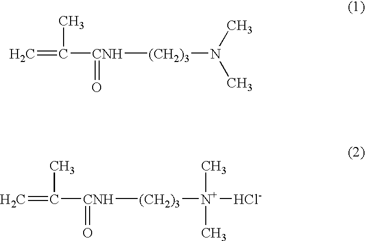

5. A developer for forming an electrostatic image comprising toner of claim 1 and a carrier covered with silicone resin.

6. An image forming method developing an electrostatic image formed on an amorphous silicon photoreceptor by digital exposure to light by a toner of claim 1.

7. An image forming method developing an electrostatic image formed on an organic photoreceptor by digital exposure to light by a toner of claim 1.

8. The toner of claim 3, wherein X is Cl.
